(19) United States
(12) Patent Application Publication
(10) Pub. No.: US 2023/0174356 A1
(43) Pub. Date: Jun. 8, 2023

(54) Motorized Motorcycle Stand

(71) Applicant: Michael Tarver, Menifee, CA (US)

(72) Inventor: Michael Tarver, Menifee, CA (US)

(21) Appl. No.: 17/744,793

(22) Filed: May 16, 2022

Related U.S. Application Data
(60) Provisional application No. 63/278,410, filed on Nov. 11, 2021.
(60) Provisional application No. 63/225,461, filed on Jul. 24, 2021.

(51) Int. Cl. B66F 7/28

(52) U.S. Cl. CPC B66F 7/28; B66F 2700/12

(57) ABSTRACT

Disclosed herein is a motorized motorcycle stand. The motorized stand includes a lifting platform. The motorized stand further includes an electric motor. The motorized stand further includes a lift column. The motorized stand further includes at least one stabilizing column. The motorized stand further includes a motor housing. The electric motor is oriented at an acute angle with respect to a plane defined by said lift column and stabilizing column.

### CROSS REFERENCE TO RELATED APPLICATIONS

The present application claims the benefit of provisional patent application Ser. No. 63/225,461, filed Jul. 24, 2021, and Ser. No. 63/278,410, filed Nov. 11, 2021, both by the present inventor. These provisional applications are incorporated by reference in their entirety.

### FIELD OF INVENTION

The present invention relates to stands for motorcycles.

### BACKGROUND AND RELATED ART

Modern racing dirtbikes typically do not use kickstands because of the risk of unintentional deployment while riding Instead, it is common to see motorcycles sitting on top of bike stands. While dirtbikes are often relatively light, the ground clearance provided by the suspension can make a dirt bike fairly tall. For this reason, lifting the motorcycle onto a stand can still require considerable strength, particularly for shorter people. What is needed is a lightweight and compact stand that can safely raise and lower a motorcycle by operation of simple controls.

### SUMMARY OF INVENTION

A motorized motorcycle lift can be used to raise a dirt bike off of the ground for cleaning, maintenance or storage. By supporting the center weight of the motorcycle, a stand permits the front and rear wheels to spin freely. The weight of the motorcycle remains balanced on the stand. A gap is designed between the upper lift platform and the base to prevent fingers from being pinched. The motor is rotated about the lift column axis so that it is oriented diagonally in the base, enabling the base to have a more compact housing. On the more compact housing, the switches to operate the motor are oriented so that their functions are intuitive without requiring additional labels.

### DESCRIPTION OF THE DRAWINGS

FIG. 1 is a view of the motorized motorcycle lift internals.

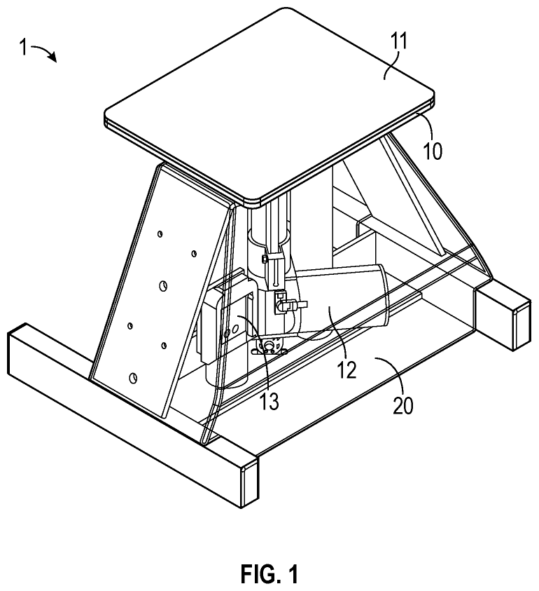

FIG. 2 is a view of the motorized motorcycle lift.

FIG. 3 is a side view of the motorized motorcycle lift internals.

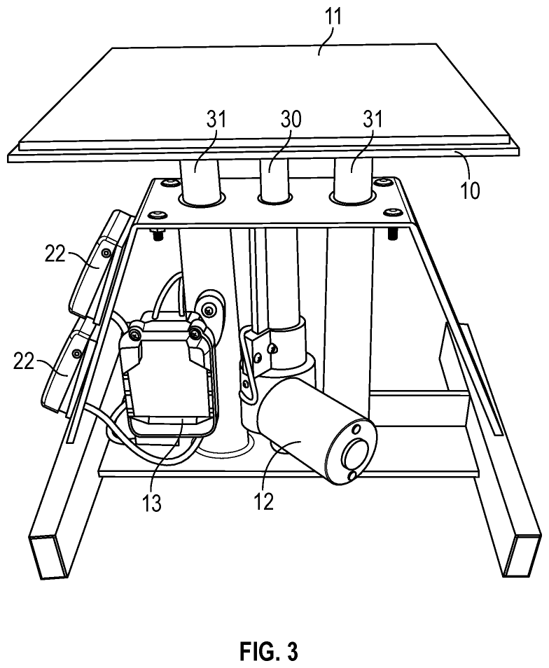

FIG. 4 is a top-down view of the motorized motorcycle lift.

FIG. 5 is a view of an adapter for battery packs.

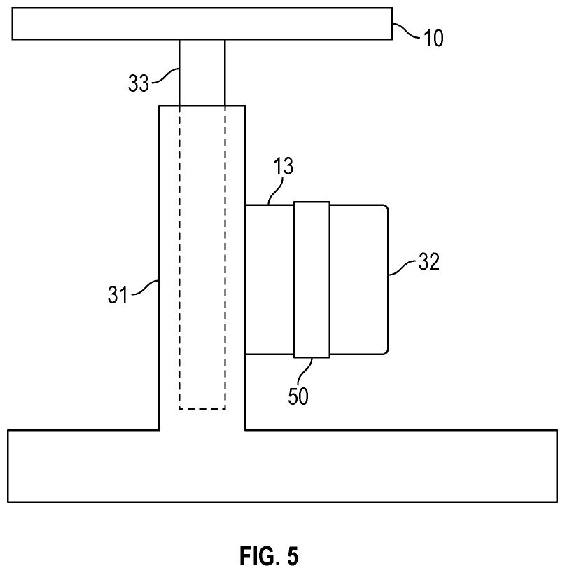

FIG. 6 is a view of a remote controller for the motorized motorcycle lift.

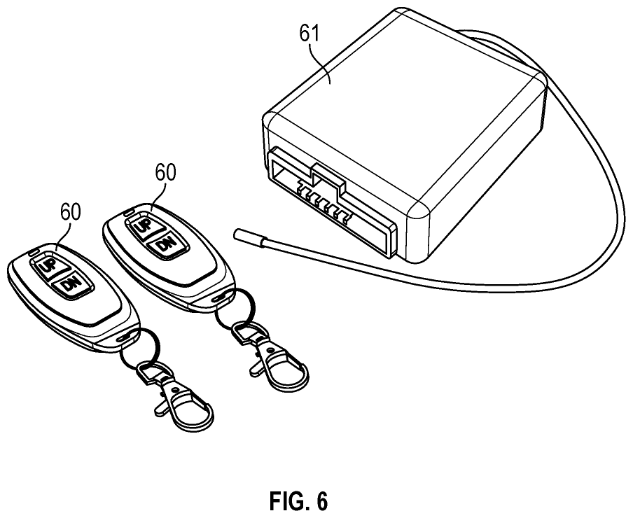

FIG. 7 is a perspective view of the motorized motorcycle lift internals.

FIG. 8 is a view of the motorized motorcycle lift holding a motorcycle.

### DETAILED DESCRIPTION

The motorized motorcycle lift 1 includes an electric motor 12 to raise and lower the platform 10. The lift includes a battery pack receiver 13, allowing a battery pack 32 to power the motor 12. The platform 10 preferably includes a rubberized surface layer 11. The lift has a frame 14 providing a stable base for the lift. The lift has a motor housing 20, and one or more buttons 22 to control the raising and lowering of the lift platform 10. A switch to disable these buttons may also be provided 21. The motor 12 moves the platform 10 via a lowering column 30. One or more stabilizing columns 31 may also be provided.

The motorized motorcycle lift may be constructed to be approximately the same size as a typical motorcycle stand, allowing for easy stowing. The operate the lift, first roll the motorcycle beside the lift, then turn the handlebars to move the engine or central portion of the motorcycle over the lift; next, straighten the motorcycle over the lift, if necessary; and finally, while holding the motorcycle upright, depressing the “up” pedal on the lift until the motorcycle 81 has reached a desired height. Once the motorcycle has reached the desired height, the lift functions as a stand. To remove the motorcycle from the stand, simply hold onto the motorcycle to keep it from falling once it has been returned to the ground and depress the “down” pedal on the lift. The motorcycle can then be steered away from the lift and used as usual.

The lift may be operated any number of times, limited primarily by the amount of charge remaining in the battery 32. In some embodiments, an external power supply may be used to charge the battery 32 and/or power the operation of the lift through a connector. The battery module or modules 32 may be charged in place within the lift or may be removed and replaced as necessary. Preferably, the lift employs a battery mounting module 50 to interface between the battery receiver 13 and battery 32 that is interoperable with easily obtainable standard battery packs such as may be available for power tools. This arrangement enables the batteries to be charged using charging stations that have been designed and made readily available for consumer battery operated power tools such as drills, saws, blowers and the like. A fuse is provided to protect the battery, motor and wiring from damage relating to current flow during operation or charging.

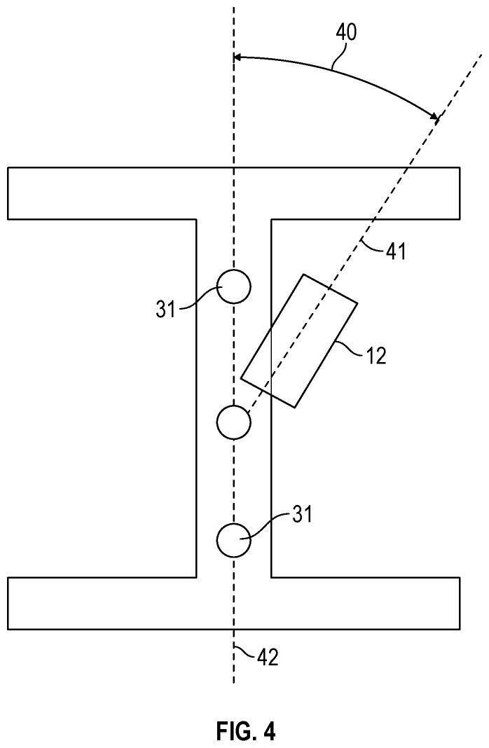

Preferably, the motor 12 is oriented to consume very little space within the housing. This can be done, for example, by rotating the motor about the vertical axis that passes through the middle of the lifting column, as depicted in FIG. 4. Preferably, axis of the motor 41 shall form an acute angle 40 with respect to the axis 42 passing through the lift column 30 and stabilizing columns 31. By rotating the motor approximately 40-60 degrees 40, the housing for the base can be narrowed while simultaneously keeping the motor from interfering with the nearest stabilizing column. In some embodiments, the nearest stabilizing column may even provide a connector to the motor body, providing additional support and flex resistance for the entire structure.

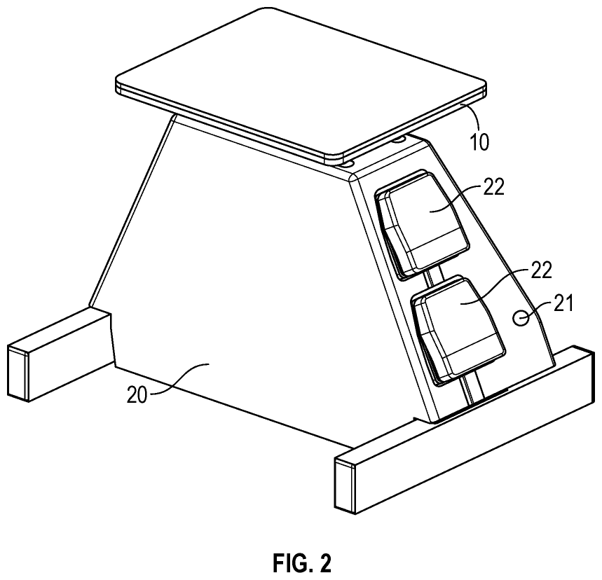

FIG. 2 shows the lift with its enclosure cover 20. Notably, the cover does not fill in the entire volume defined by the base platform and the lifting surface. Preferably, the cover will protect the internal components but be otherwise minimal. This design choice can simplify the storage, handling and transportation of the lift.

Preferably, the switch 22 to raise the platform is mounted above the switch 22 to lower the platform. In this arrangement, both switches can be made large and still fit on the narrowed body. Additionally, this arrangement permits a more intuitive identification of the function of each switch without requiring any additional written or pictorial cues. In some embodiments, an on/off or kill switch 21 may be provided on the lift. The use of such a switch may disable the raising and lowering switches, to prevent the platform from being accidentally moved.

The switches 22 may be momentary or non-momentary. The switch may require continuous pressing to operate the motor, or a single press may raise/lower the lifting platform to full extension. Based on several factors, including the amount of suspension travel of the motorcycle being lifted, it may be desirable to raise the motorcycle less than the full extension of the platform.

The stand may be provided with a wireless remote control 60 to operate the motorized lifting component. Such wireless remote control may comprise a wireless remote 60 and a control box 61 interface connected to the motorized lifting element. This control box may comprise a wireless receiver and necessary switching components. The wireless remote may operate using any suitable wireless communication means, such as radio, Bluetooth, WiFi, and so on. In some embodiments, the wireless remote control may be provided in addition to ‘up’ and ‘down’ switches on the housing. In others, the stand may be operated by wireless remote control alone, and the stand housing may be bare with regards to switches. Alternatively, the kill switch 21 can be used along with a remote system to provide more direct control in the absence of other on-device controls.

One preferred operable lift embodiment has a lifting platform 10 connected to a base with three columns 30, 31. The lifting platform 10 may be constructed of a flex resistant material, capable of supporting around 400 lbs, preferably even if loaded unevenly. The construction may be a metal, plastic, polymer or composite. In preferred embodiments, the platform is layered on top with a durable but softer material 11 to prevent scratching or other damage to the motorcycle as the lift is operated. Such a material may, in some embodiments, be a rubber or a dense neoprene. The material can be attached mechanically or chemically bonded to the lifting platform.

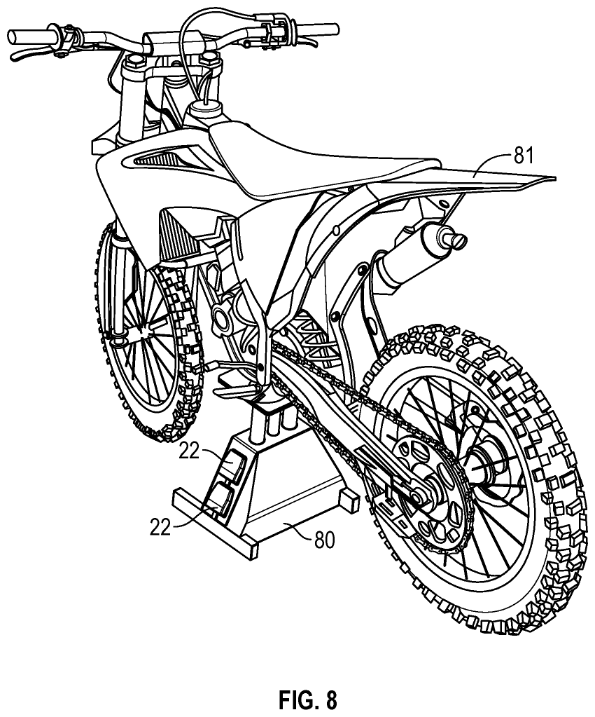

Preferably, various structural components of the stand are constructed from aluminum. Aluminum is lightweight, sufficiently rigid and relatively inexpensive. Aluminum is also fairly easy to work with as a construction material. Individual frame components may be welded together or fastened together by screws, bolts or even high-strength adhesives. While the frame body 14 may generally be kept compact to satisfy design goals, it is recommended to maintain a broad base to maintain contact with the ground and provide stability to the stand in operation. The “leg” portion of the frame 14 may be designed low and wide to provide an appropriate amount of stability to the motorcycle and stand without creating a significant tripping hazard or other obstacle to the operator. FIG. 8 shows a motorcycle 81 being suspended by a stand. The base of the stand 80 is relatively broad while the stand, overall, is fairly compact, as a result of its design.

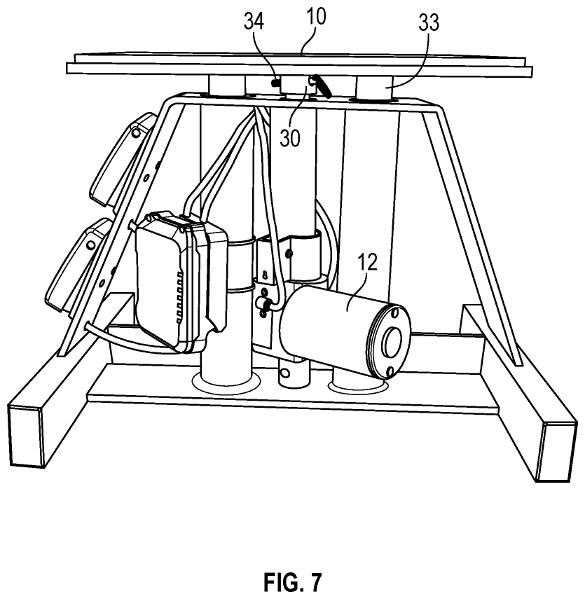

A quick release pin 34 may be used to fasten the lifting surface 10 to the lifting column 30, as shown in FIG. 7. In this way, the lifting surface may be removed quickly and replaced with another lifting surface—even one with different dimensions or other properties. For example, one platform may be dimensioned as 11 inches by 9 inches. This platform may be removed by pulling out the pin and a platform dimensioned 11 inches by 12 inches can be mounted in its place. The pin 34 can be replaced to lock the new platform in place. Preferably, the column 30 will be fitted securely into the platform 31 in such a way that the pin does not have a shear force applied to it while raising or lowering a motorcycle 81. This way, the pin need only support the 20 lb weight of the lift itself, if carrying the lift by the platform, rather than the up to 400 lb weight of a vehicle.

In a preferred embodiment, the housing of the lift is shaped asymmetrically, with the side housing the motor and battery being more angled and the side opposite the motor and battery being more vertical. In this way, the vertical surface can be used to display branding or other messages.

Although embodiments of techniques and objects have been described in language specific to features and/or methods, it is to be understood that the subject of the appended claims is not necessarily limited to the specific features or methods described. Rather, the specific features and methods are disclosed as example implementations of the present invention.

1. A motorized motorcycle stand, comprising:
a lifting platform;
an electric motor;
a lift column;
at least one stabilizing column;
a motor housing;
wherein said electric motor is oriented at an acute angle with respect to a plane defined by said lift column and stabilizing column.

2. The motorized motorcycle stand of claim 1, wherein said lifting platform incorporates a rubberized layer.

3. The motorized motorcycle stand of claim 1, wherein said lifting platform is retained to said lift column by means of a quick release pin.

4. The motorized motorcycle stand of claim 1, wherein said at least one stabilizing column is integrated into said lifting platform.

5. The motorized motorcycle stand of claim 1, further comprising two switches on said motor housing, wherein one switch is operable to raise the height of said lifting platform and one switch is operable to lower the height of said lifting platform.

6. The motorized motorcycle stand of claim 5, wherein said two switches are oriented vertically on said motor housing.

7. The motorized motorcycle stand of claim 1, further comprising a removable battery pack.

8. The motorized motorcycle stand of claim 1, further comprising a battery pack adapter.

9. The motorized motorcycle stand of claim 1, further comprising a wireless remote operable to control said electric motor.

10. The motorized motorcycle stand of claim 1, further comprising an off switch for said electric motor.
